(19) United States
(12) Patent Application Publication
(10) Pub. No.: US 2026/0112549 A1
(43) Pub. Date: Apr. 23, 2026

(54) HIGH-PERFORMANCE SOLID STATE ELECTROLYTE BASED ON SOLID ACID WITH LOW SELF-DISCHARGE AND EXCEPTIONAL IONIC CONDUCTIVITY

(71) Applicant: The American University in Cairo, Cairo (EG)

(72) Inventors: Nageh K. Allam, New Cairo (EG); Abdelrahman A. M. Ismail, Sidi Salem (EG)

(21) Appl. No.: 19/365,691

(22) Filed: Oct. 22, 2025

Related U.S. Application Data
(60) Provisional application No. 63/710,306, filed on Oct. 22, 2024.

(51) Int. Cl. H01G 11/56; H01M 10/0565

(52) U.S. Cl. CPC H01G 11/56; H01M 10/0565; H01M 2300/0082

(57) ABSTRACT

A hydrogel composition and its use as an electrolyte in energy storage devices, e.g., supercapacitors, is described. The hydrogel can include a hydrophilic polymer (e.g., polyvinyl alcohol (PVA)) matrix and a mixture of a water-retaining salt (e.g., lithium bromide (LiBr)) and a solid acid (e.g., cesium dihydrogen phosphate (CDP)) embedded in the matrix. Supercapacitors with electrolytes including the hydrogel can have high water retention and low self-discharge rates.

### PRIORITY CLAIM

This application claims the priority benefit of U.S. Provisional Patent Application Ser. No. 63/710,306 filed Oct. 24, 2024, the disclosure of which is incorporated herein by reference in its entirety.

### TECHNICAL FIELD

The presently disclosed subject matter relates to hydrogel compositions comprising a conductive solid acid, e.g., cesium dihydrogen phosphate (CDP), mixed with a water-retaining salt, e.g., lithium bromide (LiBr), and embedded in a hydrophilic polymeric matrix, e.g., polyvinyl alcohol (PVA). The compositions can be used as highly conductive electrolytes. The presently disclosed subject matter further relates to the use of the compositions in supercapacitor devices.

### BACKGROUND

An electrolyte is a key component of any energy storage device. For example, an electrolyte plays an important role in the charge storage process by providing for charge transfer and balancing between two electrodes. Additionally, the electrolyte can determine the operating working potential window of the device at which it is stable and not deteriorating. Electrolytes can be liquid, solid, or quasi-solid-state. Liquid electrolytes can be either organic or aqueous. The non-flammability, low toxicity and environmental impact, ease of maintenance, cost-effectiveness, and high specific heat capacity of aqueous electrolytes make them attractive. However, energy storage devices containing aqueous electrolytes are limited in their operational voltage to the breakdown voltage of water. On the other hand, while devices with organic electrolytes can operate at high potential near 3V, organic electrolytes typically have disadvantages, such as moderate to low energy density, high cost, and safety issues related to flammability. Furthermore, the use of liquid electrolytes can lead to a need for precise sealing/packaging, which can add volume and weight to the device. In fact, despite their strong ionic conductivity, liquid electrolytes are generally unsuited for ultrathin, lightweight, and flexible energy storage devices needed for portable and wearable electronic devices.

Thus, hydrogel electrolytes can provide an attractive alternative for a plethora of functional devices due to their flexibility and high electronic and ionic conductivity. However, currently used hydrogel electrolytes tend to lose their water content during use in devices, especially under operation. For example, current hydrogel electrolytes used in batteries, supercapacitors, electronic devices, and the like can become dehydrated upon cycling. This can result in device malfunction and/or loss of performance due to loss of ionic conductivity.

Accordingly, there is an ongoing need for additional hydrogel compositions suitable for use as electrolytes, including those with improved water retention.

### SUMMARY

The presently disclosed subject matter provides, in some embodiments, a hydrogel comprising a solid acid, a water-retaining salt, and a hydrophilic polymeric matrix. The solid acid can be selected from cesium dihydrogen phosphate (CDP), rubidium dihydrogen phosphate, one of the corresponding sulfates, or mixtures thereof. The water-retaining salt can be a lithium halide salt, e.g., lithium bromide (LiBr), lithium chloride (LiCl), lithium iodide (Lil) or a mixture thereof. In some embodiments, the hydrophilic polymeric matrix is polyvinyl alcohol (PVA). Alternatively, the hydrophilic polymeric matrix can be or can further comprise another hydrophilic polymer or polymers, e.g., polyacrylamide (PAM), hyaluronic acid (HA), or a nitrile-based polymer, such as polyacrylonitrile (PAN).

In some embodiments, the presently disclosed subject matter relates to the use of the hydrogel as an electrolyte, for example, in an energy storage device, such as a supercapacitor. In some embodiments, the presently disclosed hydrogel electrolyte provides improved water retention and reduced self-discharge compared to currently used hydrogel electrolytes.

Accordingly, it is an object of the presently disclosed subject matter to provide a hydrogel, to provide devices, e.g., supercapacitors, comprising the hydrogel as an electrolyte, and to methods of preparing a hydrogel electrolyte.

An object of the presently disclosed subject matter having been stated hereinabove, and which is achieved in whole or in part by the compositions and methods disclosed herein, other objects will become evident as the description proceeds when taken in connection with the accompanying Figures as best described herein below.

### BRIEF DESCRIPTION OF THE DRAWINGS

Exemplary implementations of the subject matter described herein will now be explained with reference to the accompanying drawings, of which:

FIGS. 1A-1D are a series of graphs showing the ionic conductivity (FIG. 1A), galvanostatic charge-discharge (GCD) curves (FIG. 1B), potential window (FIG. 1C), and capacitance (FIG. 1D) of devices comprising exemplary electrolytes containing cesium dihydrogen phosphate (CDP) in a polyvinyl alcohol (PVA) matrix, lithium bromide (LiBr) in a PVA matrix, or both CDP and LiBr in a PVA matrix. In FIGS. 1A, 1C, and 1D, data is provided for devices comprising a 0.4 molar (M) CDP in PVA hydrogel state electrolyte (CDP@PVA), a 1 M LiBr in PVA hydrogel state electrolyte (LiBr@PVA), a 0.4 M CDP+1 M LiBr in PVA hydrogel state electrolyte (CDP+LiBr@PVA//HS), and a 0.4 M CDP+1 M LiBr in PVA solid state (dried) electrolyte (CDP+LiBr@PVA//SS). FIG. 1B shows the GCD curves for a device comprising a CDP+LiBr@PVA/SS electrolyte. The CDP+LiBr@PVA electrolyte is sandwiched between two stainless steel strip electrodes in the device used to provide the data for FIG. 1A. In the devices used to provide data for FIGS. 1B, 1C, and 1D, the electrolytes are sandwiched between activated carbon-based electrodes. The devices were characterized at ambient temperature within selected potential ranges.

FIG. 2 illustrates a series of graphs showing the differential scanning calorimetry (DSC) curves of different hydrogel systems: one with lithium bromide (LiBr) in polyvinyl alcohol (PVA) (top left), one with cesium dihydrogen phosphate (CDP) in PVA (top right) and one with a mixture of LiBr and CDP in PVA (bottom left).

FIGS. 3A-3F are a series of graphs showing the electrochemical characterization of exemplary electrolytes of the presently disclosed subject matter used in activated carbon-based devices prepared by sandwiching an electrolyte between two activated carbon-based electrodes and monitoring their electrochemical behavior. The fabricated devices were electrochemically characterized using a Biologic SP 300 potentiostat/galvanostat under hydrogel (HS) and solid state (SS) electrolyte conditions where the electrolyte comprises 0.4 molar (M) cesium dihydrogen phosphate (CDP) and 1 M in a polyvinyl alcohol (PVA) matrix (i.e., CDP+LiBr@PVA//HS or CDP+LiBr@PVA//SS). More particularly, FIG. 3A is a graph showing cyclic voltammetry (CV) measurements (current (in milliampere (mA)) versus voltage (in volts (V))) for a device comprising a CPD+LiBr@PVA//SS electrolyte at different potential windows, revealing that 2 V is the most suitable potential window for operation. FIG. 3B is a graph showing the charge-discharge curves for the device from FIG. 3A. FIG. 3C is a graph showing current (in mA) versus voltage (in V) for a device comprising a CDP+LiBr@PVA//SS electrolyte at a potential window of 2 V at different scan rates. FIG. 3D is a graph showing specific capacitance (in farad per gram (Fg⁻¹)) versus current density (in ampere per gram (Ag⁻¹)) for a device comprising a CDP+LiBr@PVA//SS electrolyte. FIG. 3E is a graph showing the self-discharge profile (potential (in volts (V)) versus time (in seconds (s))) of a device containing a CDP+LiBr@PVA//HS electrolyte. FIG. 3F is a graph showing specific power (in watts per kilogram (Wkg⁻¹) versus specific energy (in watt-hours per kilogram Wh kg⁻¹) for a CDP+LiBr@PVA//SS electrolyte The calculated energy and power densities for the device were 49.4 Wh/kg and 593.33 W/kg at 1 ampere per gram (A/g), respectively, and decreased to 24.08 Wh/kg and 7225 W/kg at 10 A/g. This indicates a strong balance between energy storage and power delivery capabilities, underscoring the effectiveness of the 0.4M-CDP/1M-LiBr@PVA//SS electrolyte.

FIG. 4 is a schematic diagram illustrating an exemplary energy storage device using a hydrogel electrolyte of the presently disclosed subject matter disposed between two electrodes, i.e., an anode and a cathode.

### DETAILED DESCRIPTION

Although some of the aspects of the subject matter disclosed herein have been stated hereinabove, and which are achieved in whole or in part by the presently disclosed subject matter, other aspects will become evident as the description proceeds when taken in connection with the accompanying drawings as best described hereinbelow.

The presently disclosed subject matter will now be described more fully. The presently disclosed subject matter can, however, be embodied in different forms and should not be construed as limited to the embodiments set forth herein below and in the accompanying Examples. Rather, these embodiments are provided so that this disclosure will be thorough and complete, and will fully convey the scope of the embodiments to those skilled in the art.

### I. DEFINITIONS

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long-standing patent law convention, the terms “a”, “an”, and “the” refer to “one or more” when used in this application, including the claims.

The term “and/or” when used in describing two or more items or conditions, refers to situations where all named items or conditions are present or applicable, or to situations wherein only one (or less than all) of the items or conditions is present or applicable.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” can mean at least a second or more.

The term “comprising”, which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

Unless otherwise indicated, all numbers expressing quantities of time, temperature, concentration, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about”, when referring to a value is meant to encompass variations of in one example ±20% or ±10%, in another example ±5%, in another example ±1%, and in still another example ±0.1% from the specified amount, as such variations are appropriate to perform the disclosed methods.

The term “hydrogel” as used herein refers to a porous, permeable material (e.g., solid material) comprising a three-dimensional network (e.g., a three-dimensional cross-linked network) of hydrophilic polymeric chains (i.e., “a polymeric matrix”) that can swell but not dissolve in an aqueous medium or to the hydrated material formed by contacting the network of hydrophilic polymeric chains with an aqueous medium. For example, following contact with an aqueous medium, the hydrogel can comprise hydrated hydrophilic polymeric chains and “hold” water, e.g., to form a liquid or semi-solid material. In some embodiments, the hydrogel can swell to comprise at least 10% (e.g., about 10% to about 20%) by weight or volume of water or an aqueous fluid. When the hydrogel is dehydrated/unswollen, it can also be referred to as a “dehydrated hydrogel” or “solid state” system.

### II. Hydrogels and Related Methods and Devices

As described hereinabove, hydrogel electrolytes are known for their high ionic conductivity and mechanical flexibility but can suffer from poor water retention as a result of dehydration during operation in electronic devices. Dehydration of the electrolyte decreases ionic conductivity, negatively impacting overall performance of the device.

Conductive solid acids have been used as electrolytes in fuel cells but have not been previously reported for use in supercapacitors. Despite providing good self-discharge rates, solid acid electrolytes, like hydrogels, can suffer due to dehydration.

According to an aspect of the presently disclosed subject matter, a hydrogel is provided that comprises or consists of (i) a hydrophilic polymeric matrix (i.e., a three-dimensional network of PVA chains) and (ii) a mixture comprising a solid acid (e.g., CDP) and a water-retaining salt (e.g., LiBr) embedded in the polymer matrix. The hydrogel can be used as a hydrogel electrolyte in a variety of devices, e.g., batteries, capacitors, supercapacitors, and optoelectronic devices. Devices constructed from these electrolytes can exhibit intrinsic redox activity, exceptional water retention or regeneration to maintain performance, and significantly slower self-discharge rates compared to existing technologies. The electrolytes can also demonstrate stable electrochemical performance over extended cycles.

In some embodiments, the presently disclosed subject matter provides a method for the production (e.g., large-scale production) of the hydrogel, paving the way for the development of next-generation energy storage devices with enhanced efficiency and stability. In some embodiments, the method of producing the hydrogel comprises preparing a first aqueous solution comprising a solid acid and a water-retaining salt; preparing a second aqueous solution comprising a hydrophilic polymer; and adding a first volume of the first solution to a second volume of the second solution.

In some embodiments, the presently disclosed subject matter further provides a device, e.g., an energy storage device, comprising the hydrogel as an electrolyte. The device can further comprise one or more electrodes (e.g., a cathode and an anode). In some embodiments, the device is a supercapacitor. In particular, by incorporating a solid acid, such as CDP, the presently disclosed hydrogel can provide supercapacitors with slow self-discharge, thus providing for a much slower loss of stored energy over time compared to previous devices. The improved water retention can provide consistent ionic conductivity. By maintaining consistent ionic conductivity and mitigating self-discharge, the use of the presently disclosed hydrogel as an electrolyte can result in reliable and predictable performance of the energy storage devices over extended charge and discharge cycles.

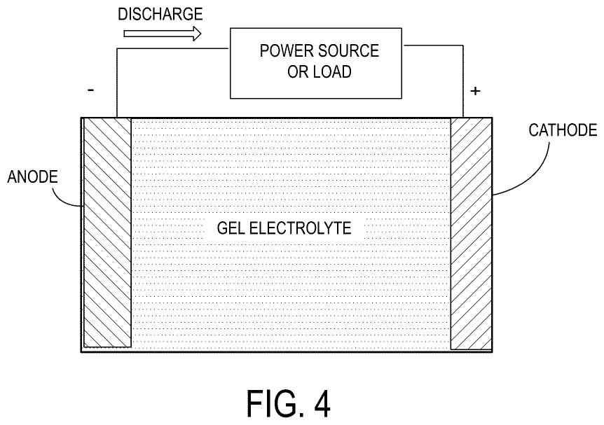

FIG. 4 illustrates an exemplary energy storage device where the electrolyte is disposed between two electrodes, i.e., a cathode and an anode. The electrodes (e.g., the cathode and/or the anode) and comprise activated carbon and/or graphite. In some embodiments, at least one electrode can comprise activated carbon configured on a graphite sheet.

### Examples

The following Examples provide illustrative embodiments. In light of the present disclosure and the general level of skill in the art, those of ordinary skill will appreciate that the following Examples are intended to be exemplary only and that numerous changes, modifications, and alterations can be employed without departing from the scope of the presently claimed subject matter.

### Preparation of Cesium Dihydrogen Phosphate (CDP):

To synthesize CDP powder, cesium carbonate (Cs₂CO₃) and phosphoric acid (85% H₃PO₄) were used as precursors. First, 10 g Cs₂CO₃ is dissolved in deionized water, followed by the addition of 7 g phosphoric acid in stoichiometric amounts. This results in an effervescent reaction, releasing heat, yet a clear solution remains. Methanol is then added to precipitate the solid CDP, forming a white, snow-like precipitate. After washing with methanol, the precipitate is dried using a vacuum setup.

### Preparation of CDP+LiBr@PVA Hydrogels (CDP+LiBr@PVA//HS):

Firstly, we prepared different concentrations of CDP@PVA (0.3 M, 0.4 M, 0.5 M CDP @PVA)(1:2). The PVA solution was prepared by dissolving 3 g of PVA in 20 mL DI water. Then, different percentages of CDP to LiBr (1:2, 1:3, and 1:2.5) were added to determine percentages that provided a suitable amount of water retention. The ratio of CDP to LiBr can be adjusted. CDP facilitates dehydration, while LiBr is enhances water retention.

Preparation of CDP+LiBr@PVA solid-state electrolyte (CDP+LiBr@PVA//SS).

A combined CDP and LiBr (1:2.5) solution was mixed with PVA solution (1:2). The solution was then used to make membranes of different thicknesses. The 250 μm thick membrane has been chosen as the optimum thickness. The films were then dried at room temperature and RH=53±2% for 48 h.

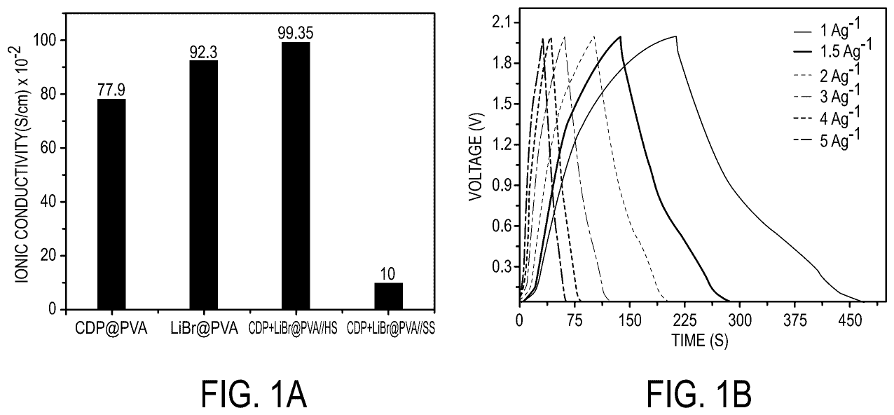

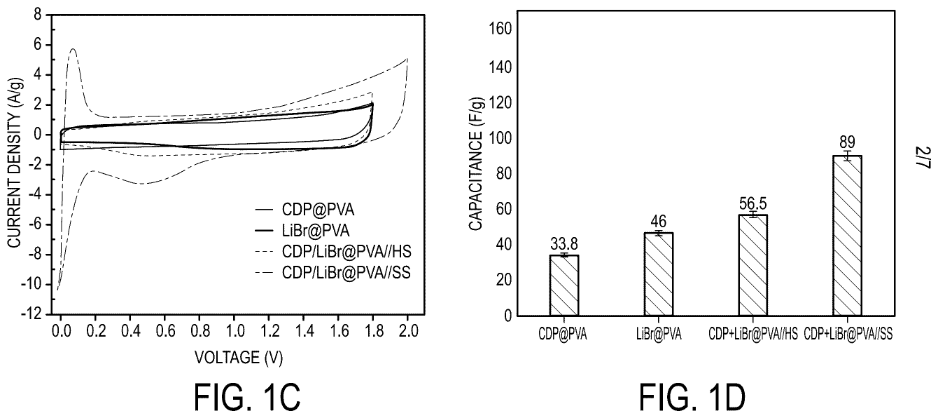

### Ionic Conductivity Measurements (FIG. 1A):

To measure the ionic conductivity of the hydrogel sample (CDP+LiBr@PVA), potentioelectrochemical impedance spectroscopy (PEIS) was used. In a typical experimental setup, a two-electrode ion-blocking cell with stainless steel strip electrodes separated by a fixed distance was used. Gel electrolytes of varying concentrations were placed between the SSs electrodes within a 1×1 cm² area. The PEIS measurements were performed at ambient temperature at open circuit voltage (OCV). The frequency ranges from 1 Hz to 100 kHz, with an applied amplitude of 5 mV. The ionic conductivity (σ) was calculated using Eq. 1:

$$σ = L / Ra \qquad ( 1 )$$

where L is the distance between the stainless-steel strips; the thickness of the used gel electrolyte in cm, a is the area of the electrode in cm², and R is the bulk resistance in Ω.

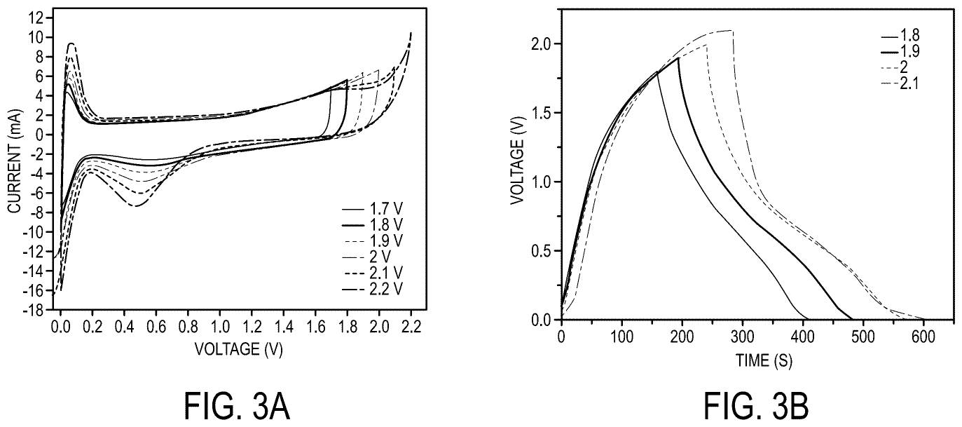

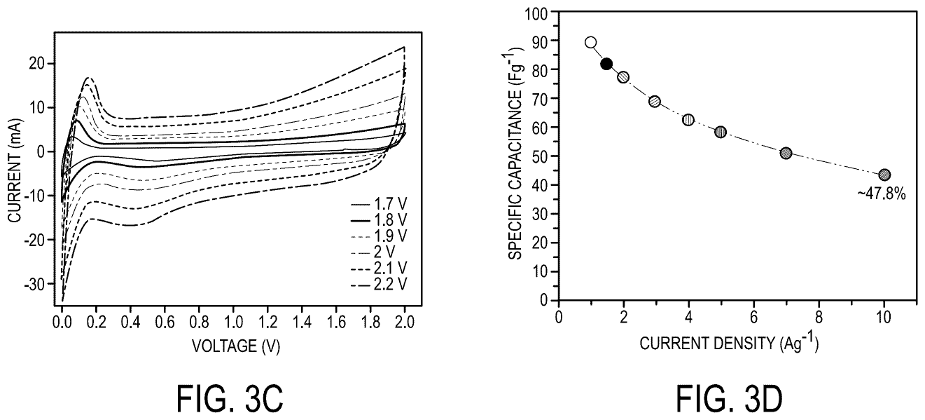

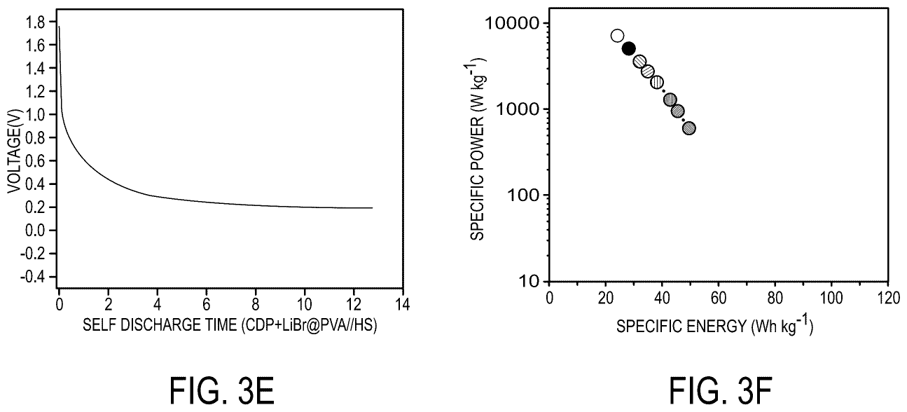

### Electrochemical Measurements (FIGS. 1B-1D and 3A-3F):

The electrochemical performance of fabricated devices using 3—and 2-electrodes set-ups with electrolyte was investigated. The electrolyte can be electrochemically characterized using cyclic voltammetry (CV), chronoamperometry (CA), open circuit voltage (OCV), charge-discharge cycling (CDC), and potentiostatic electrochemical impedance spectroscopy (PEIS). Due to the non-linear discharge profiles of the as-fabricated composites and the device, specific capacitance can be obtained from the CED curves by using the integral form of the C_{CED}=I×dt/ΔV as depicted by Eq. 2.

$${C}_{CED} = \frac{2 I \int V dt}{{m ( Δ V )}^{2}} \qquad ( 2 )$$

where I is the applied current (A), ∫ V dt is the area under the discharging curve, m is the mass of the active material, and ΔV is the potential window (V). The specific energy density (E) and the corresponding power density (P) are calculated using Eqs. 3 and 4.

$$E = \frac{{C}_{S} Δ {V}^{2}}{2 \times 3.6} \qquad ( 3 )$$

$$P = \frac{E \times 3600}{Δ t} \qquad ( 4 )$$

where Cₛ is the calculated capacitance, ΔV refers to the potential window after correction for the iR drop, and Δt is the discharge time (s).

### Results:

FIGS. 1A-1D, 2, and 3A-3F illustrate the properties of the presently disclosed composition and devices using the composition as an electrolyte. For example, FIG. 1C shows the potential window for devices with different electrolytes at a scan rate of 20 mV/s. A device comprising a previously described LiBr@PVA hydrogel electrolyte (see U.S. Patent Application Publication No. 2024/0290552, the disclosure of which is incorporated herein by reference in its entirety), and devices comprising other hydrogel state electrolytes achieved a maximum operating window of 1.8 V. Beyond this potential, observable parasitic reactions occurred, likely due to high water retention in the gel. The device comprising a 0.4M-CDP@PVA//HS electrolyte exhibited a rectangular CV shape, indicative of the predominance of electric double-layer capacitance (EDLC) in ion storage achieving a specific capacitance of 33.8 F/g. See FIG. 1D. In contrast, the 1M-LiBr@PVA//HS and 0.4M-CDP/1 M-LiBr@PVA//HS devices showed deviations from ideal EDLC behavior, attributed to the presence of redox-active species (LiBr). This interaction enhances the capacitance properties and overall electrochemical performance, owing to the ability of bromide to exhibit multiple valence states achieving higher specific capacitance over the 0.4M-CDP@PVA//HS electrolyte-based device. Furthermore, the 0.4M-CDP/1 M-LiBr@PVA//SS electrolyte-based device demonstrated the highest area under the CV curve, signifying the greatest specific capacitance among the hydrogel electrolytes tested, with a specific capacitance value of 89 F/g. Without being bound to any one theory, it is believe that this superior performance can be explained by the hydrophilic nature of the PVA polymer, which facilitates the adsorption of water at low concentrations while retaining it in a bound, non-freezable state. See Li et al., ACS Nano 2024, 18(4): 3101-3114. Consequently, the 0.4M-CDP/1 M-LiBr@PVA//SS electrolyte-based device exhibited enhanced capacitive behavior compared to the other candidates. Additionally, this device displayed two distinct redox peaks at 0.1 V, attributed to the Br⁻/Br₃⁻ redox reaction that occurs dominantly at the positive electrode. See Fic et al., Batteries & Supercaps. 2020, 3(10): 1080-1090.

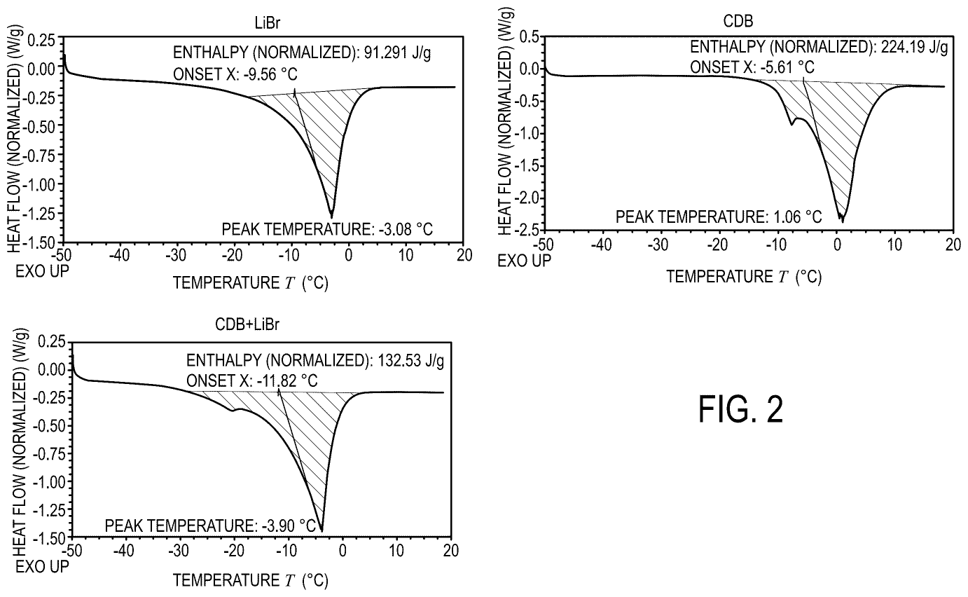

Based on the findings, the 0.4M-CDP/1 M-LiBr@PVA//SS electrolyte-based device underwent comprehensive electrochemical evaluation at various scan rates and current densities to assess reaction kinetics and rate capability. FIG. 3C illustrates the cyclic voltammograms (CVs) of the 0.4M-CDP/1 M-LiBr@PVA//SS device at scan rates ranging from 5 to 100 mV/s. The CVs reveal two distinct peaks at a potential of 0.1 V across all scan rates, indicating the device's stability under varying kinetic conditions. Furthermore, the galvanostatic charge-discharge (GCD) profiles of the 0.4M-CDP/1 M-LiBr@PVA//SS device displayed a stable response without observable plateaus or IR drop, suggesting optimal operational conditions with no contribution from parasitic reactions. See FIG. 3B. Notably, the quasi-triangular shape of the GCD profiles was preserved even under more aggressive reaction conditions, demonstrating the device's robustness and the predomination of pseudocapacitive behavior. Δt a current density of 10 A/g, the 0.4M-CDP/1 M-LiBr@PVA//SS device achieved a specific capacitance of 43.35 F/g, which increased by 47.8% when the current density was reduced to 1 A/g, as shown in FIG. 3D. This performance highlights the excellent electrochemical characteristics of the device, even under kinetically sluggish conditions. Additionally, the solid-state device achieves an energy density of about 50 Wh/kg, which is notably high for a carbon-based system. See FIG. 3F. The self-discharge profile revealed a significant drop in open-circuit voltage from nearly 2 V to 0.3 V within the first 3 hours. Following this initial drop, the voltage gradually decreased from 0.3 V to slightly above 0.2 V, maintaining a stable plateau over the next 10 hours, as shown in FIG. 3E. These results indicate the superior performance of the assembled 0.4M-CDP/1 M-LiBr@PVA//SS electrolyte-based device. The anti-freezing properties of the presently disclosed compositions are shown by the DSC results of FIG. 2, which show that the CDP/LiBr@PVA//HS (hydrogel system) achieves higher freezing points.

### REFERENCES

All references listed in the instant disclosure, including but not limited to all patents, patent applications and publications thereof, and scientific journal articles, are incorporated herein by reference in their entireties to the extent that they supplement, explain, provide a background for, and/or teach methodology, techniques, and/or compositions employed herein. No admission is made that any reference (or a portion of any reference) is relevant prior art. Applicants reserve the right to challenge the accuracy and pertinence of any cited reference.
Allam N K and Ismail A A, Self-regenerative electrolytes with intrinsic redox activity for energy storage devices. United States Patent Application Publication No. 2024/0290552.
El Sharkawy H M, Ismail A A, Allam N K. Environmentally Benign Natural Hydrogel Electrolyte Enables a Wide Operating Potential Window for Energy Storage Devices. ACS Sustainable Chemistry & Engineering. 2024 Feb. 21; 12(9):3517-26.
Fic K, Morimoto S, Frqckowiak E, Ishikawa M. Redox Activity of Bromides in Carbon-Based Electrochemical Capacitors. Batteries & Supercaps. 2020 Oct;3(10):1080-90.
Ghanem L G, Shaheen B S, Allam N K. “Salt-in-fiber” electrolyte enables high-voltage solid-state supercapacitors. ACS Applied Energy Materials. 2022 May 10;5(5):6410-6.
Ismail A A, Ghanem L G, Akar A A, Khedr G E, Ramadan M, Shaheen B S, Allam N K. Novel self-regenerative and non-flammable high-performance hydrogel electrolytes with anti-freeze properties and intrinsic redox activity for energy storage applications. Journal of Materials Chemistry A. 2023; 11(30):16009-18.
Li C, Zhu X, Wang D, Yang S, Zhang R, Li P, Fan J, Li H, Zhi C. Fine Tuning Water States in Hydrogels for High Voltage Aqueous Batteries. ACS nano. 2024 Jan. 18; 18(4):3101-14.

It will be understood that various details of the presently disclosed subject matter may be changed without departing from the scope of the presently disclosed subject matter. Furthermore, the foregoing description is for the purpose of illustration only, and not for the purpose of limitation.

1. A hydrogel comprising: (i) a hydrophilic polymeric matrix; and (ii) a mixture comprising water-retaining salt and a solid acid embedded in the polymeric matrix.

2. The hydrogel of claim 1, wherein the water-retaining salt is a lithium halide, optionally lithium bromide (LiBr), lithium chloride (LiCl), lithium iodide (Lil), or a mixture thereof.

3. The hydrogel of claim 1, wherein the solid acid is selected from cesium dihydrogen phosphate (CDP), rubidium dihydrogen phosphate, cesium hydrogen sulfate, rubidium hydrogen sulfate, or a mixture thereof.

4. The hydrogel of claim 1, wherein the hydrophilic polymeric matrix comprises polyvinyl alcohol (PVA), polyacrylamide (PAM), hyaluronic acid (HA), or a nitrile-containing polymer.

5. The hydrogel of claim 1, wherein the hydrogel comprises LiBr, CDP, and PVA.

6. The hydrogel of claim 5, wherein the hydrogel comprises (i) about 1 part of an aqueous solution comprising CDP and LiBr in molar ratio of about 1:2 CDP:LiBr to about 1:3 CDP:LiBr, optionally about 1:2.5 CDP:LiBr; and (ii) about 2 parts of an aqueous solution comprising about 0.15 grams per milliliter (g/ml) PVA.

7. A device comprising: an electrolyte comprising a hydrogel including (i) a hydrophilic polymeric matrix; and (ii) a mixture comprising water-retaining salt and a solid acid embedded in the polymeric matrix.

8. The device of claim 7, wherein the device is selected from a battery, a capacitor, a supercapacitor, and an optoelectronic device.

9. An energy storage device comprising:
(a) a cathode;
(b) an anode; and
(c) an electrolyte comprising a hydrogel disposed between the anode and the cathode, the hydrogel comprising (i) a hydrophilic polymeric matrix; and (ii) a mixture comprising water-retaining salt and a solid acid embedded in the polymeric matrix.

10. The energy storage device of claim 9, wherein the cathode and/or the anode comprises activated carbon, graphite, or stainless steel.

11. The energy storage device of 9, wherein the energy storage device is a supercapacitor.

12. The energy storage device of claim 9, wherein the energy storage device has an operating potential of about 2.0 volts (V).

13. The energy storage device of claim 9, wherein the energy storage device has a specific capacitance of up to about 90 F/g.

14. The energy storage device of claim 9, wherein the energy storage device has an energy density of about 50 Wh/kg.

15. The energy storage device of claim 9, wherein, during a self-discharge test, the energy discharge device takes about 12 hours to drop from about 1.8 V to about 0.2 V.
